(19) United States
(12) Patent Application Publication
(10) Pub. No.: US 2025/0180235 A1
(43) Pub. Date: Jun. 5, 2025

(54) STAGED REGENERATED LIQUID DESICCANT DEHUMIDIFICATION SYSTEMS

(71) Applicant: Mojave Energy Systems, Inc., Sunnyvale, CA (US)

(72) Inventors: Michael BENEDICT, Sunnyvale, CA (US); Eugene S. BEH, Portola Valley, CA (US); Francisco E. TORRES, San Jose, CA (US)

(73) Assignee: Mojave Energy Systems, Inc., Sunnyvale, CA (US)

(21) Appl. No.: 18/796,790

(22) Filed: Aug. 7, 2024

Related U.S. Application Data
(63) Continuation of application No. 17/204,703, filed on Mar. 17, 2021, now Pat. No. 12,085,293.

(51) Int. Cl. F24F 11/30; B01D 53/14; B01D 53/18; B01D 53/26; B01D 53/28; F24F 3/14; F24F 11/00; F24F 110/20; F24F 110/22

(52) U.S. Cl. CPC F24F 11/30; B01D 53/1406; B01D 53/1425; B01D 53/18; B01D 53/263; B01D 53/28; F24F 3/1417; F24F 3/1429; F24F 11/0008; B01D 2252/10; F24F 2003/1458; F24F 2110/20; F24F 2110/22

(57) ABSTRACT

A system comprises a liquid desiccant regeneration system, a first air contactor stage, and a second air contactor stage. The regeneration system has a first stage with a first concentration output and first diluted output, and a second stage with a second concentration output, different from the first concentration output, and a second diluted output. The first air contactor stage is coupled to the first concentrated output to form a first output air stream having a reduced water content and a first diluted air contactor output. The second air contactor stage is coupled to the second concentrated output to form a second output air stream having a reduced water content and a second diluted air contactor output. Both diluted air contactor outputs are recirculated into the regeneration system, and the output air streams are combined.

### CROSS-REFERENCE TO RELATED APPLICATIONS

This application is a continuation of U.S. patent application Ser. No. 17/204,703, filed Mar. 17, 2021, entitled “Staged Regenerated Liquid Desiccant Dehumdification Systems”, the contents of which is hereby incorporated by reference in its entirety.

### TECHNICAL FIELD

This disclosure relates generally to air dehumidifying and conditioning systems that utilize regeneration of a liquid desiccant at a plurality of liquid desiccant concentrations.

### BACKGROUND

While necessary for comfort, and in parts of the world survival, air conditioning and dehumidification have a significant negative impact on the environment. Currently, air conditioning systems produce heat that measurably increases urban temperatures, and they have the potential to discharge unsafe chemicals, such as greenhouse gases, to the atmosphere. To do this, they also consume vast amounts of energy, primarily electricity. With the climate's ever-increasing temperatures, the demand for air conditioning systems will continue to increase such that energy demand from dehumidification and air conditioning systems is expected to triple in the next thirty years.

Using liquid desiccant regenerators in an air conditioning system can reduce energy consumption as compared with vapor compression-based air conditioning systems. Liquid desiccant-based systems “fully” regenerate the liquid desiccant-they regenerate to the strongest concentration an air contactor requires to provide the desired delivery conditions of the resulting, treated air stream. However, dehumidification also takes place when liquid desiccant concentrations are below the designed threshold concentration. Described herein are dehumidification and air conditioning systems and processes that reduce both energy consumption and overall system costs by utilizing staged regeneration of liquid desiccants at a plurality of liquid desiccant concentrations.

### SUMMARY

The present disclosure is directed to a system comprising a liquid desiccant regeneration system, a first air contactor stage, and a second air contactor stage. The liquid desiccant regeneration system comprises a first stage with a first concentrated output stream having a first concentration of liquid desiccant and a first diluted output stream. The regeneration system also comprises a second stage with a second concentrated output stream having a second concentration of liquid desiccant, different than the first concentration, and a second diluted output stream. The system includes a first air contactor stage coupled to the first concentrated output stream, which disposes a first input air stream having a first water content, by percent mass, in fluid communication with the first concentrated output stream to form a first output air stream having a second water content, by percent mass, lower than the first water content and a first diluted air contactor output stream. The first diluted air contactor output stream is circulated back into the liquid desiccant regeneration system. The system further includes a second air contactor stage coupled to the second concentrated output stream, which disposes a second input air stream having a third water content, by percent mass, in fluid communication with the second concentrated output stream to form a second output air stream having a fourth water content, by percent mass, lower than the third water content and a second diluted air contactor output stream. The second diluted air contactor output stream is circulated back into the liquid desiccant regeneration system, and the first and second output air streams are combined.

In another embodiment, a system comprises an air contactor. The air contactor comprises a first input stream of liquid desiccant having a first concentration of desiccant and a second input stream of liquid desiccant having a second concentration of desiccant where the second concentration is higher than the first concentration. The air contactor further comprises an input air stream disposed in fluid communication with the first input stream of liquid desiccant and with the second input stream of liquid desiccant to produce a diluted output stream of liquid desiccant and an output air stream having a water content, by mass, lower than that of the input air stream.

A further embodiment is directed to a system comprising a first liquid desiccant regeneration system, a second liquid desiccant regeneration system, a first air contactor stage, and a second air contactor stage. The first liquid desiccant regeneration system is configured to produce a first concentrated output stream having a first concentration of liquid desiccant. The second liquid desiccant regeneration system is coupled to the first concentrated output stream and configured to produce a second concentrated output stream having a second concentration of liquid desiccant different than the first concentration. The first air contactor stage is coupled to the first concentrated output stream, which disposes a first input air stream having a first water content, by mass, in fluid communication with the first concentrated output stream to form a first output air stream having a second water content, by mass, lower than the first water content and a first diluted output stream. The first diluted output stream is circulated back into the first liquid desiccant regeneration system. The second air contactor stage is coupled to the second concentrated output stream, which disposes a second input air stream having a third water content, by mass, in fluid communication with the second concentrated output stream to form a second output air stream having a fourth water content, by mass, lower than the third water content and a second diluted output stream. The second diluted output stream is circulated back into the second liquid desiccant regeneration system, and the first and second output air streams are combined.

The above summary is not intended to describe each disclosed embodiment or every implementation of the present disclosure. The figures and the detailed description below more particularly exemplify illustrative embodiments.

### BRIEF DESCRIPTION OF THE DRAWINGS

The discussion below refers to the following figures, wherein the same reference number may be used to identify the similar/same component in multiple figures. However, the use of a number to refer to a component in a given figure is not intended to limit the component in another figure labeled with the same number. The figures are not necessarily to scale.

FIG. 1 is a block diagram of a regenerated liquid desiccant dehumidification system;

FIG. 2 is a diagram of an electrochemically regenerated liquid desiccant dehumidification system according to an example embodiment;

FIG. 2A is a diagram of an electrochemical liquid desiccant regeneration system according to an example embodiment;

FIG. 3 is a schematic diagram of staged electrochemical liquid desiccant regeneration with staged dehumidification according to an example embodiment;

FIG. 4 is a schematic diagram of the flows between an air contactor and a regeneration system as shown in FIG. 4 according to an example embodiment;

FIG. 5 is a block diagram of thermal control of a staged electrochemical liquid desiccant regenerator coupled with a staged air contactor according to an example embodiment;

FIGS. 6A-D are block diagrams of staged regenerated liquid desiccant dehumidification systems according to various example embodiments; and

FIG. 7 is a flow chart of a method according to an example embodiment.

### DETAILED DESCRIPTION

The present disclosure relates to regenerated liquid desiccant dehumidification systems, and in certain embodiments, electrochemically regenerated systems. A liquid desiccant system may be used in, among other things, heating, ventilation, and air-conditioning (HVAC). As set forth above, air conditioning is an energy intensive process and is responsible for nearly 10% of U.S. electricity consumption, with dehumidification accounting for more than half of the energy load in humid regions. The systems described herein provide an efficient, thermodynamic approach to dehumidification for air conditioning utilizing staged regeneration of the liquid desiccant.

The systems each utilize two, or more, liquid desiccant streams having different salt concentrations supplied to one or more air contactors to produce a stream of dehumidified air. Instead of regenerating liquid desiccant to a single, higher, concentrated output stream that would provide the desired delivery conditions of the resulting, treated air stream, multiple streams (e.g., at least two) are supplied at lower and/or increasing concentrations up to that single stream concentration. For treated air going from a hot and humid condition to a cool and dry condition, the difference in water concentrations (i.e., relative humidity of the before and after air streams) may be as much as 100%. For example, to obtain a 90° F. and 90% relative humidity output air condition may only require a desiccant concentration of 15% of lithium chloride (LiCl) desiccant dissolved in water, but to obtain a delivery condition of 70° F. and 60% relative humidity may require a desiccant concentration of 30% LiCl or more. However, a significant amount of dehumidification can take place with a concentration of desiccant well below 30%.

Using staged regeneration provides for reduced energy usage, reduced costs, and reduced system complications. Since regeneration energy is nonlinearly proportional to liquid desiccant concentration, if a portion of the liquid desiccant solution is not fully concentrated, the amount of energy used for regeneration is reduced. For electrochemical liquid desiccant regenerators, as described herein, concentrating to high concentrations (e.g., greater than 30%) increases operating costs. By staging concentration of the liquid desiccant at lower concentrations, operating costs (e.g., energy) as well as capital costs in terms of the size of the overall system and individual components (e.g., membranes) is reduced. For example, the desiccant concentration level is proportional to the size of an electrochemical regenerator membrane; however, electrochemical membranes are significantly more expensive than air contactor materials. Lower concentrations may use smaller, or fewer, membranes, or different types of membranes that tailored for the lower concentration. Further, to maintain desiccant capability in the air contactor, latent heat must be rejected. Using a staged air contactor provides multiple opportunities for external cooling of the liquid desiccant, which avoids inefficiencies associated with single point external cooling and complications associated with internal cooling in an air contactor.

The staged regeneration of liquid desiccants described herein is applicable to a variety of liquid desiccant dehumidifying systems including thermally regenerated, electrochemically regenerated systems, and combinations thereof. For example, thermal regeneration systems involve one or more of a variety of evaporative processes, including regeneration by heating, by reduced pressure (e.g. membrane pervaporation), by azeotropic removal, etc. However, exemplary embodiments herein are described with respect to an electrochemical regeneration system that utilizes a redox-assisted electrodialysis process that enables a membrane-based liquid desiccant air conditioning system. In this redox-assisted electrodialysis (ED) process, an aqueous solution of a redox-active species is circulated between the anode and cathode of an electrochemical stack to concentrate ionic solutions, eliminating thermodynamic phase changes driven by the heat or pressure necessary for vapor compression (VC) or desiccant based air conditioning. Liquid desiccants (e.g., aqueous solutions of salts such as lithium chloride) will absorb moisture from air across a membrane interface. Diluted liquid desiccants will be efficiently re-concentrated, avoiding the latent heat input required to evaporate water. It is estimated that the enhanced efficiency of this cycle leads to 1.5 quads of energy savings yearly by 2030.

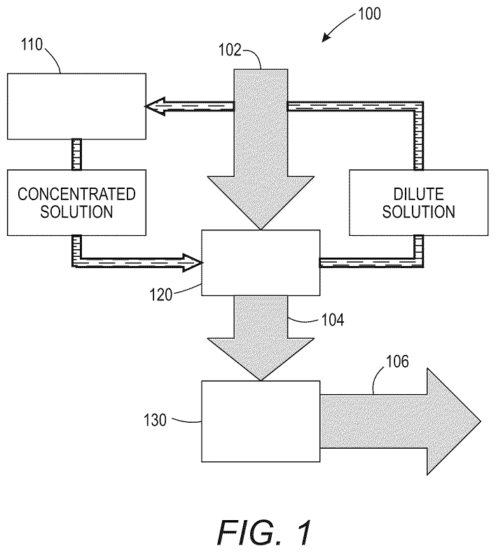

In FIG. 1, a diagram illustrates a dehumidification system 100 utilizing a liquid desiccant regeneration system 110, here an electrochemical liquid desiccant regeneration system, in conjunction with an air contactor 120. The regeneration system outputs a single concentrated solution of liquid desiccant (e.g., an aqueous salt solution) to the air contactor 120. As used throughout this disclosure, an air contactor refers to a liquid to air mass and energy exchanger, which includes a membrane energy exchanger, and in certain embodiments is a dehumidifying air contactor. Air is flowed over the concentrated solution (e.g., having a concentration of up to 40%) of liquid desiccant either directly or via a membrane where water from the air stream is absorbed by the liquid desiccant stream. The air stream may be outside air, return air, or exhaust air from an enclosed space (e.g., building) that the system 100 is used to supply, or a combination of two or more of outside, exhaust, and return air. After absorbing the water from the air, the liquid desiccant stream is diluted and a single stream is output from the air contactor 120. The diluted liquid desiccant stream is then cycled back to the regeneration system 110 for regeneration (i.e., increased concentration of liquid desiccant).

In addition, a dehumidified air stream 104 (i.e., having a lower water content by percent mass than air stream 102) is output from the air contactor 120. A heat transfer system 130 can optionally be used to remove sensible heat from the air to supply a conditioned air stream 106 to the enclosed space (i.e., building). In other embodiments, sensible heat is removed earlier, or at other points, in the system for improved thermodynamic efficiencies. Sensible heat refers to the amount of energy needed to increase, or in this case decrease, the temperature of the air stream 104 independent of phase changes. The heat transfer system 130 may include any type of known heat exchange system such as vapor compression, indirect evaporative cooling, chilled water or glycol, and/or heat pipes. Also, latent heat needs to be rejected from the system: from the liquid desiccant before or after the air contactor and/or from the input or output air streams. Latent heat can be as much as 80% of the total load for outdoor air, where 1 Ton is equivalent to 3.5 kW and 5 kg water per hour.

In systems with a single solution stream between the regeneration system and an air contactor, the concentrated liquid desiccant solution enters the air contactor at the highest needed concentration and leaves at some lower concentration of liquid desiccant. In these systems, a high flow rate of solution has a low liquid desiccant concentration change across the air contactor (e.g., a change of about 2%) and requires more energy to concentrate the solution. However, there may be less need for integration with heat rejection as latent heat can be removed externally such as from the input or output liquid desiccant stream for the air contactor. Alternatively, low flow rates of the solution provide an increased, or maximum, concentration change across the air contactor (e.g., a change of about 15%) and use less energy to concentrate the solution. However, additional temperature control for the air contactor may be needed such as with added flow paths of cooling fluid with high flow rates for internal cooling within the air contactor. These operating conditions can be varied as design choices and are better understood with a more detailed description of an electrochemical regeneration system.

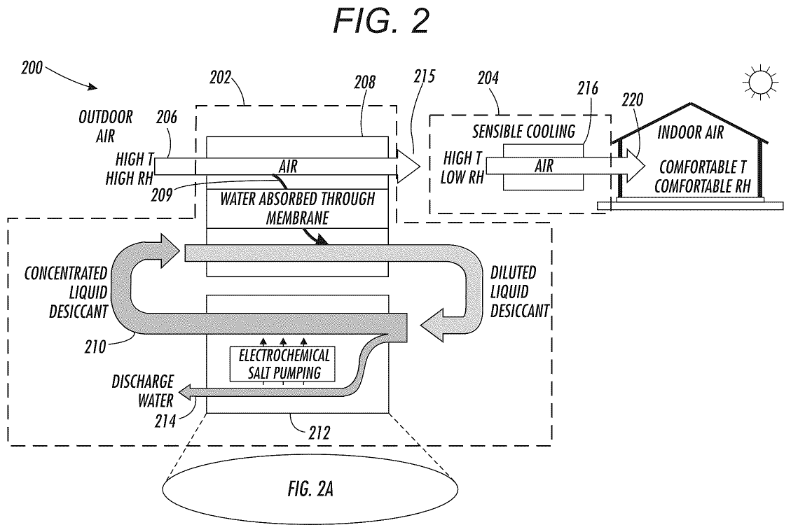

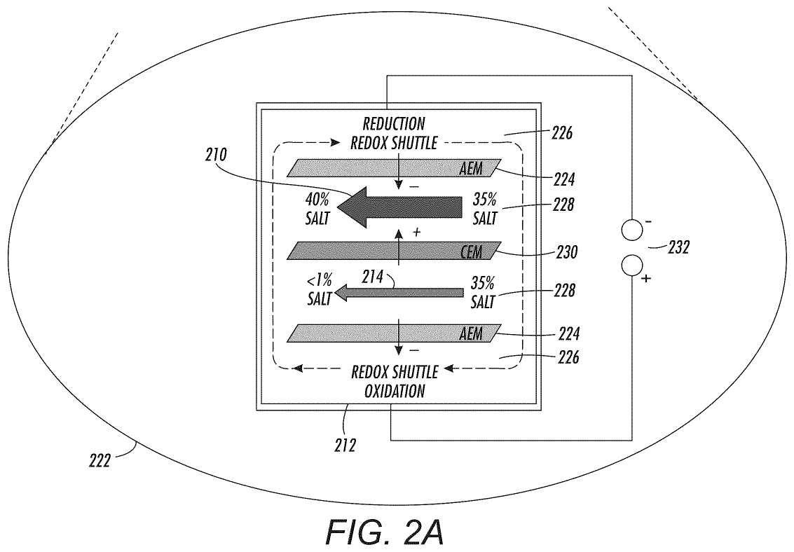

FIG. 2 illustrates a diagram of an electrodialytic liquid desiccant air conditioning (ELDAC) system 200 as described above in accordance with certain embodiments. The system 200 includes a desiccant section 202 and a cooling section 204. In the desiccant section 202, outdoor air 206 (and/or recirculated air) is forced across an air contactor 208 such as an air-liquid interface or liquid-carrying membrane dryer. In certain embodiments, the air 206 may be outside air of high temperature and high relative humidity (RH). Water 209 from the air 206 is absorbed at the air contactor 208 into a concentrated liquid desiccant 210, e.g., an aqueous salt solution, is then passed through a redox-assisted electrochemical regenerator 212 to separate dilute stream 214 (e.g., discharge water) and re-concentrate the desiccant stream 210. Example salts that may be used for the desiccant include, for example, LiCl, NaCl, LiBr, and CaCl2.

The humidity (i.e., water content by percent mass of the humid air) is reduced in the air 215 leaving the desiccant section 202, wherein it is cooled by the cooling section 204. This cooling section 204 may include an evaporator 216 and other components not shown (e.g., condenser, compressor). Because the air 215 entering the cooling section 204 has lower relative humidity compared to the outside/recirculated air 206, the evaporator 216 is more efficient and can reduce the temperature of the cooled air 220 by a greater amount than if the evaporator 216 had to also condense moisture from the incoming air 215. Experimental results measuring the energy used by redox-assisted electrodialysis to concentrate ionic aqueous solutions show that ELDAC system 100 can have a regeneration specific heat input (RSHI) less than 0.05 kBTU/lb, which is up to 30 times lower than currently used thermal regeneration methods.

As seen in the detail view 222 of FIG. 2A, redox-assisted regenerator 212 has two outer ion exchange membranes 224 that separate the outer redox channels 226 from the inner concentrate 210 and dilute 214 streams. In this example the outer ion exchange membranes 224 are configured as anion exchange membranes (AEM). The concentrate 210 and dilute 214 streams are separated by a central ion exchange membrane 230, which in this example is a cation exchange membrane (CEM). In other configurations, the central ion exchange membrane 230 may be an AEM and the outer membranes 224 may be CEMs. An efficient membrane pair of one CEM and one AEM in the redox-assisted regenerator 212 has a Coulombic efficiency above 70%.

The four (or more) chambered desalination cell may use either one redox-active species that is circulated around the anode and cathode, where it undergoes faradaic reactions at both electrodes, or two redox-active species that are each confined to the anode or cathode respectively. An external voltage 232 induces oxidation or reduction in redox-active shuttle molecules, driving ion movement across the membranes 224, 230 without splitting water or producing other gaseous byproducts (e.g. chlorine) and creating at least two streams: re-concentrated desiccant 210 and discharge water 214. The percentages of salt concentrations shown in FIG. 2A are examples only-both inlets do not need to have the same concentration and the output concentrations may have a range of differences in concentrations. This goal can be achieved over multiple stages. One proposed redox shuttle is a positively charged ferrocene derivative such as (1,1′-bis(3-(trimethylammonio)propyl) ferrocene/1,1′-bis(3-(trimethylammonio)propyl) ferrocenium, [BTMAP-Fc]2+/[BTMAP-Fc]3+) 234, which is non-toxic, highly stable, has very rapid electrochemical kinetics and negligible membrane permeability. Other redox shuttle solutions may include ferrocyanide/ferricyanide ([Fe(CN)6]4−/[Fe(CN)6]3−) or a negatively charged ferrocene derivative. The moving parts of the system may include low pressure pumps for liquid circulation and fans for air circulation. Additional details of this type of four-channel, electrodialytic, stack with redox shuttle assist can be found in commonly-owned U.S. Pat. No. 10,821,395, which is hereby incorporated by reference in its entirety.

As discussed above, latent heat must be rejected from the dehumidification system. Using external rejection, the liquid desiccant may be circulated with a higher flow rate and a less complicated and smaller air contactor design may be utilized since the heat removal system is external to the air contactor. However, there is a smaller gradient in the liquid desiccant concentration change due to lower osmotic losses. Alternatively, internal latent heat rejection may be used for systems circulating the liquid desiccant at a lower flow rate. The lower average concentration leads to fewer losses (e.g., due to electroosmotic drag, resistance, Coulombic efficiency), but the lower flow rate can also lead to less regeneration.

In certain circumstances, an air contactor would utilize a low liquid desiccant flow rate with a modest temperature increase (e.g., five degrees) from input to output and a concentration decrease of about 15%. The air contactor would also include cooling fluid (e.g., water) with a temperature increase of about five degrees and a counter flow (counter to the flow of cooling fluid and liquid desiccant) of air having a decrease in temperature of about 10° C. and a decrease in relative humidity (e.g., from 80% to 50%). However, to achieve these delivery conditions (e.g., temperature and relative humidity decreases), the air contactor would produce about a 15% concentration gradient (e.g., concentration changing from input 30% to diluted output of 15%), which would require the liquid desiccant regenerator to reconcentrate the liquid desiccant back up to a 30% salt concentration. This is challenging for the regenerator membranes and difficult due to osmotic drag, and in certain circumstances, impossible due to electroosmotic drag. When regeneration takes place at the highest concentration for desired delivery conditions, the flow rate must also be higher since less water is absorbed.

Instead of regenerating the liquid desiccant to the highest concentration necessary for a system's most stringent delivery conditions, staged regeneration and dehumidification utilizes lower concentrations of smaller volumes of solution in incremental stages to ramp up to the final concentration. Embodiments described herein utilize an electrochemical regenerator, as described above in connection with FIGS. 2 and 2A unless otherwise described, to produce two or more concentrated liquid desiccant output solutions in connection with two, or more, air contactor stages. However, the embodiments may be used with other liquid desiccant regeneration systems such as thermal regeneration and reverse osmosis systems. Unlike the systems described above, which utilize a single regenerator concentrated output stream, regeneration and dehumidification occur in stages using two or more streams of liquid desiccant having a smaller concentration than that of a system using a single regenerator concentrated output stream. Various systems utilizing staged liquid desiccant regeneration in combination with two or more air contactor stages are further described below.

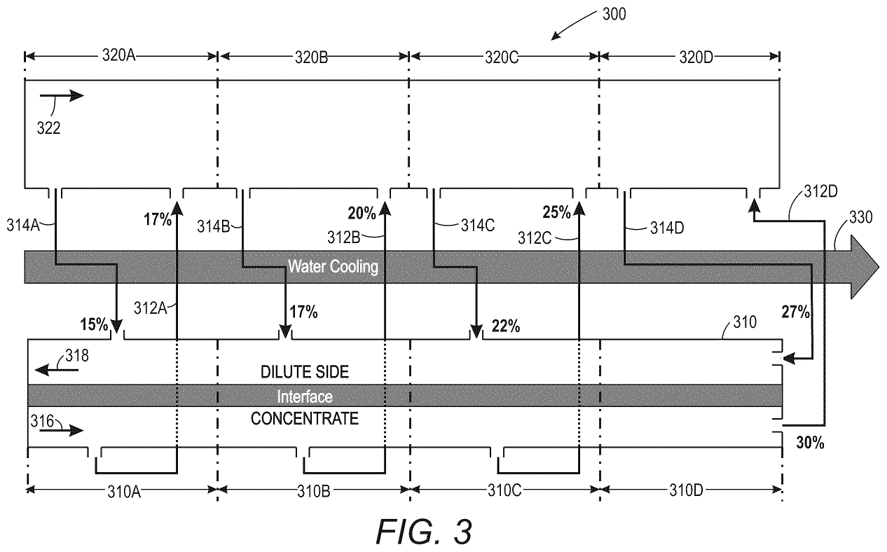

FIG. 3 illustrates a system 300 including a staged regenerator 310 coupled with a staged air contactor 320. While the staged regenerator 310 is described as an electrochemical regenerator, the stages may be similarly utilized in a reverse osmosis driven regenerator or in a thermal regeneration system. Each stage of the regenerator 310A-D outputs a concentrated stream of liquid desiccant 312A-D and each stage of the air contactor 320A-D returns a diluted stream of liquid desiccant 314A-D. The stages of both the regenerator 310A-D and air contactor 320A-D are demarcated by dashed lines. Although the stages are shown as being aligned with each other, this is not required, and the respective stages within a component (i.e., regenerator, air contactor) may have varying sizes. As can be seen, the concentrated streams 312A-D are output from the concentrated liquid desiccant chamber of the regenerator 310, and the diluted streams 314A-D are returned to the diluted desiccant chamber which is separated from the concentrated desiccant by an interface, or membrane.

An overview of an example embodiment of the stages A-D may be understood from FIG. 3. However, the concentrations used herein are merely exemplary and embodiments of the described systems may be designed using any range of concentrations where at least one of the staged concentrated outputs is less than the highest concentration for the designed air delivery conditions. Using FIG. 3, the highest concentration for the designed delivery conditions is 30% salt concentration, as shown in concentrated output stream 312D. Thus, a first stage of the regenerator 310A outputs a first concentrated liquid desiccant stream having a lower concentration of 17% to a first air contactor stage 320A. The first air contactor stage 320A returns a first diluted output stream 314A having a concentration of 15% to the first stage of the regenerator 310A. A subsequent stage outputs a second concentrated liquid desiccant stream 312B having a concentration higher than that of output stream 312A, e.g., 20%, to a subsequent air contactor stage 320B. The air contactor stage 320B returns a second diluted output stream 314B having a concentration of 17%, which is higher than that of output stream 314A, to the subsequent stage of the regenerator 310B.

A third stage outputs a third concentrated liquid desiccant stream 312C having a concentration higher than that of output stream 312B, e.g., 25%, to a third air contactor stage 320C. The air contactor stage 320C returns a third diluted output stream 314C having a concentration of 22%, which is higher than that of output stream 314B, to the third stage of the regenerator 310C. Next, a fourth, and here final, stage outputs a fourth concentrated liquid desiccant stream 312D having a concentration higher than that of output stream 312C, e.g. 30%, to a fourth air contactor stage 320D. The air contactor stage 320D returns a final diluted output stream 314D having a concentration of 27%, which is higher than that of output stream 314C, to the fourth stage of the regenerator 310D. While it is shown that the diluted output streams 314A-D are returned to specific stages, or areas, of the regenerator 310, they may be recirculated, or split, to any portion of the dilute liquid desiccant chamber of the regenerator 310.

As explained above, the regenerator chambers have the concentrated liquid desiccant and diluted desiccant streams flowing in opposing directions through the regenerator 310. For example, the concentrated desiccant flows in the direction of arrow 316 toward increasing concentrations, and the diluted solution flows in the direction of arrow 318 toward increasingly diluted concentrations. Thus, the regenerator 310 provides desiccant at lower concentrations than the final output concentration at incremental stages along flow path of the concentrating desiccant. While FIG. 3 illustrates four stages, the systems described herein can have any number of stages that utilize at least two concentrated desiccant output streams of differing concentrations.

The dehumidifying air contactor is also shown in stages 320A-D. Input air may flow along the stages of the air contactor in the direction of arrow 322 to increasingly expose the air stream to higher concentrations of liquid desiccant and increasingly remove water from the air stream. In alternative embodiments, air may be introduced at different stages of the air contactor to provide varying levels of dehumidification. In certain embodiments, the air streams exposed to the different air contactor stages 320A-D are combined to output an air stream at designed delivery conditions.

The staged system also allows for improved latent heat removal. The staged concentration liquid desiccant output streams 312A-D provide an opportunity to remove heat at multiple input locations to the air contactor 320, which further reduces energy required for latent heat removal. The heat removal system represented by arrow 330 utilizes cooling fluid, such as water, that cools the liquid desiccant at two or more inputs to the air contactor 320. The heat removal system may utilize direct or indirect heat removal such as one or more of evaporative cooling, dry cooling, and vapor compression. In alternative embodiments, the heat removal system 330 may be integrated into the air contactor 320, for example, at one or more stages in addition, or as an alternative to, an external cooling system.

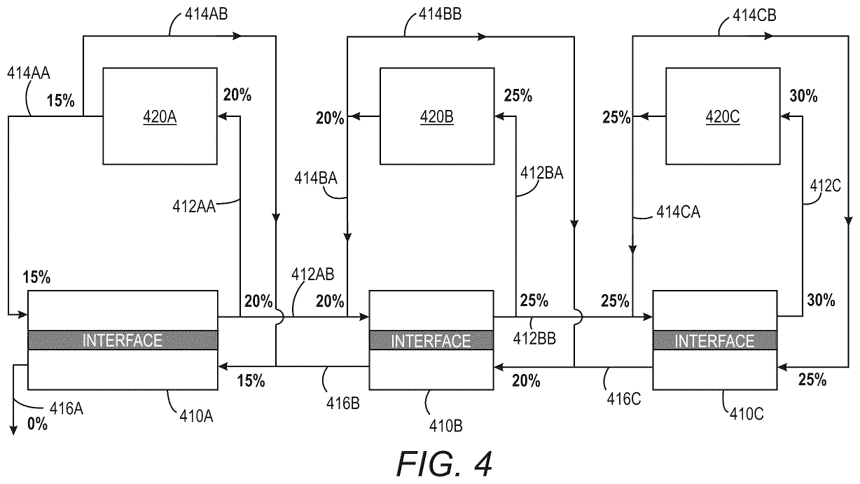

The flows of the various concentrate and diluted liquid desiccant streams are shown in more detail in FIG. 4. In this embodiment three stages are shown, but as set forth above any number of stages may be utilized and the concentrations are merely provided as examples. As above, a first regenerator stage 410A outputs a concentrated liquid desiccant stream having a concentration of 20% where a first portion of the stream 412AA is input to a first air contactor stage 420A and a second portion of the stream 412AB is input for further concentration to a second regenerator stage 410B. The first air contactor stage 420A outputs a diluted liquid desiccant stream having a concentration of 15% where a portion of the stream 414AA is recirculated to the concentrated feed of the first regenerator stage 410A to be further concentrated and a second portion of the stream 414AB is recirculated to the diluted feed of the first regenerator stage 410A.

The second regenerator stage 410B outputs a concentrated liquid desiccant stream having a concentration of 25%, or higher than the output concentrated stream of the first stage, where a first portion of the stream 412BA is input to a second air contactor stage 420B and a second portion of the stream 412BB is input for further concentration to a subsequent, or third, regenerator stage 410C. The second air contactor stage 420B outputs a diluted liquid desiccant stream having a concentration of 20% where a portion of the stream 414BA is recirculated to the concentrated feed of the second regenerator stage 410B to be further concentrated and a second portion of the stream 414BB is recirculated to the diluted feed of the second regenerator stage 410B. The second regenerator stage 410B also outputs a diluted stream 416B having a concentration of 15% to the first regenerator stage 410A for further dilution. While the output concentration of the second air contactor stage 414BA, BB is shown as the same concentration as the input stream 412AB concentration to the second regenerator stage 410B, this is not required; they may be different.

The third regenerator stage 410C outputs a concentrated liquid desiccant stream having a concentration of 30%, or higher than the output concentrated stream of the second stage and if the final stage of the system, substantially equal to the highest concentration required for the designed delivery conditions. The stream 412C is input to a third air contactor stage 420C. The third air contactor stage 420C outputs a diluted liquid desiccant stream having a concentration of 25% where a portion of the stream 414CA is recirculated to the concentrated feed of the third regenerator stage 410C to be further concentrated and a second portion of the stream 414CB is recirculated to the diluted feed of the third regenerator stage 410C. The third regenerator stage 410C also outputs a diluted stream 416C having a concentration of 20% to the second regenerator stage 410B for further dilution. Again, the output concentration of the second air contactor stage 414BA, BB is not necessarily the same concentration as the input stream 412AB concentration to the second regenerator stage 410B.

The first contactor stage 410A is shown as outputting a diluted stream 416A having a zero (or substantially zero) percent concentration of liquid desiccant, which may be expelled from the system. However, in certain embodiments, diluted stream 416A may have a higher concentration of liquid desiccant, though less than the concentration of the diluted streams 414AA, 414AB, and 416B input to the first stage 410A, and this stream may be further regenerated (i.e., concentrated) by inputting 416A to a second, different air contactor, which is a humidifying air contactor. Similar to the air contactor stages 420A-C, the second air contactor may be a liquid to air mass and energy exchanger, including a membrane energy exchanger.

At the second air contactor, air is flowed over stream 416A, either directly or via a membrane, where water from stream 416A is absorbed by the air stream. The air stream may be outside, ambient air from the environment, or exhaust air. The resulting humidified air is output from the second air contactor as an output, humidified air stream that is returned to the environment external to the components of the dehumidification system. The resulting concentrated liquid desiccant stream is then recirculated to one or more of the regenerator stages 410A-C for further use in the regeneration process. The second air contactor liquid desiccant output stream has a concentration of liquid desiccant higher than that of stream 416A, and in certain embodiments, the second air contactor output stream has a concentration in a range of about 2-35%.

The various flows shown in FIG. 4 may occur simultaneously, or the timing of various stages of the system may also be individually controlled. For example, one or more regenerator stages 410A-C and/or one or more air contactor stages 420A-C may be operated simultaneously, or in various combinations. The system may include storage containers, with or without bypass valves, at various positions throughout the system to store/contain diluted and/or regenerated solutions of liquid desiccant to take advantage of energy savings (e.g., to operate energy intensive portions of the system during off-peak or less expensive times).

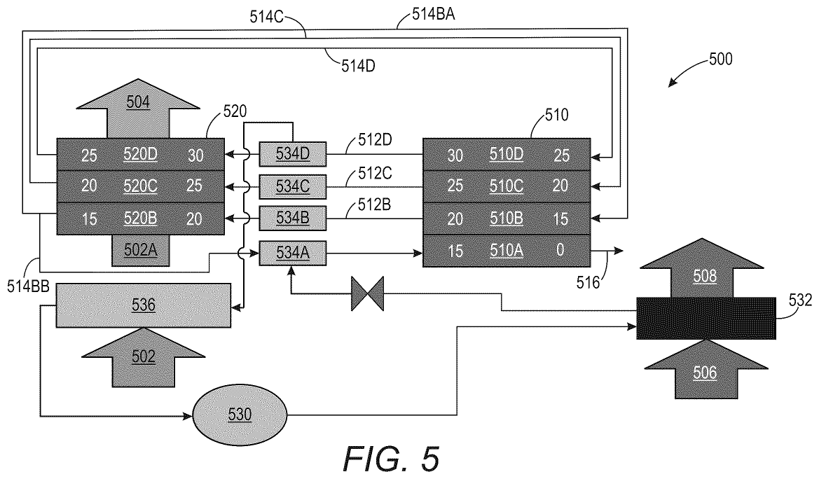

FIG. 5 illustrates an example system with a staged liquid desiccant regenerator 510 coupled with a staged air contactor 520 along with sensible and latent heat removal. As discussed above, the regenerator stages 510B-D couple with respective air contactor stages 520B-D to provide liquid desiccant streams of different concentrations. For example, regenerator stage 510D outputs a stream 512D having a concentration of 30% to air contactor stage 520D, which outputs a diluted stream 514D having a salt concentration of 25%, which is recirculated to an input of at least one stage of the regenerator 510, e.g., stage 510D. Regenerator stage 510C outputs a stream 512C having a concentration of 25% to air contactor stage 520C, which outputs a diluted stream 514C having a salt concentration of 20%, which is recirculated to an input of at least one stage of the regenerator 510, e.g., stage 510C.

Regenerator stage 510B outputs a stream 512B having a concentration of 20% to air contactor stage 520B, which outputs a diluted stream having a salt concentration of 15%, which is recirculated to an input of at least one stage of the regenerator 510. In the embodiment shown, the diluted output stream is split into a first stream 514BA that is recirculated as input to regenerator stage 510B and into a second stream 514BB that is recirculated as input to regenerator stage 510A. Similarly, outputs from any of the air contactor stages 520B-D can be input to the regenerator 510 at any one stage, or split amongst two or more stages 510A-D. The air contactor 520 is staged to precisely control the liquid desiccant concentrations at each stage.

In certain embodiments, the regenerator and the air contactor do not have an equal number of stages. For example, some of the stages are coupled to the air contactor (e.g., stages 510B-D) and some of the stages internally regenerate the liquid desiccant (e.g., stage 510A). In further embodiments, one or more regenerator stages may be coupled to a second, humidifying air contactor as described above. For example, output stream 516 may couple to another air contactor or alternatively be used as a drain for the system.

Liquid desiccant within air contactor 520 will also heat up as moisture is transferred from the air to the liquid desiccant. As the liquid desiccant and air increase in temperature, the capability of the liquid desiccant to absorb moisture from air is diminished. Thus, maintaining a lower temperature in the air contactor improves operability and efficiency of the air contactor. This can be achieved in several ways including pre-cooling the air entering the air contactor, pre-cooling the liquid desiccant, and/or introducing a third cooling fluid inside the air contactor.

The embodiment of FIG. 5 shows the evaporative side of a vapor compression system in thermal contact with each stage of liquid desiccant before entering air contactor 520, which reduces, or minimizes, the complication of the air contactor 520 design while providing staged cooling. While the staged cooling is illustrated as a vapor compression system, cooling may be accomplished through alternative methods such as with chilled water or indirect evaporative cooling. As shown, each concentration feed of desiccant may be separately cooled to control the input temperature of each concentration of desiccant at each stage of the air contactor 520. For example, input desiccant 512B is cooled at 534B, input desiccant 512C is cooled at 534C, and input desiccant 512D is cooled at 534D. In alternative embodiments, one or more cooling stations may cool one or more of the input desiccant streams 512B-D. Cooling station 534A also cools the liquid desiccant stream 514BB that is recirculated to the regenerator 510.

In addition to pre-cooling the liquid desiccant, FIG. 5 shows an embodiment where the incoming air 502 to the air contactor 520 is also pre-cooled. The incoming air 502 is exposed to an evaporator 536, which is coupled to the cooling stations 534A-D. After removal of sensible heat by exposure to the evaporator 536, the cooled incoming air 502A is exposed to one or more stages 520B-D of the air contactor 520 and leaves as conditioned air stream 504. The conditioned air stream 504 is then provided to the intended enclosed space (e.g., building).

Cooling fluid (e.g., gas or liquid) leaves the evaporator 536 to enter a vapor compressor 530 where the temperature of the cooling fluid is increased. The fluid is then provided to a condenser 532 that receives outside or vent/exhaust air 506 to expel heated outside air 508. The condenser 532 may be another air contactor as described above. The cooling fluid is then coupled to the liquid desiccant cooling stations 534A-D, where such coupling includes an expansion valve. In certain embodiments, the vapor compression system may be used in connection with internal cooling, e.g., added cooled fluid flows, in one or more stages of the air contactor 520.

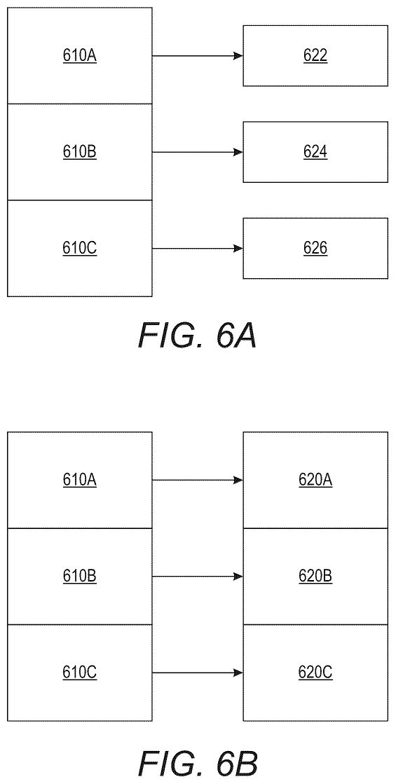

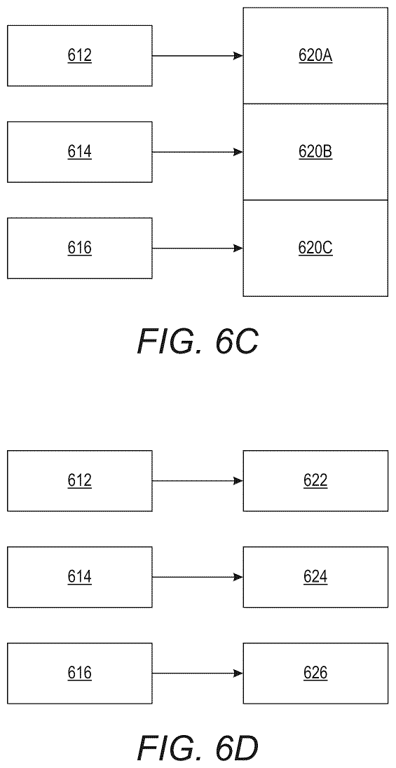

FIGS. 6A-D illustrate various configurations of the staged regenerator and staged air contactor systems described above. FIG. 6A illustrates a single regenerator having stages 610A-C coupled with multiple air contactors 622, 624, 626. For example, regenerator stages 610A-C may be included in a single housing, while one or more of air contactors 622, 624, 626 have discrete housings. FIG. 6B illustrates a single regenerator having stages 610A-C coupled with a single air contactor having multiple stages 620A-C. As set forth above, regenerator stages 610A-C may be included in a single housing and air contactor stages 620A-C may be included in a single housing. FIG. 6C illustrates multiple regenerators 612, 614, 616 coupled to a single air contactor having multiple stages 620A-C. For example, one or more of regenerators 612, 614, 616 may have discrete housings, while air contactor stages 620A-C may be included in a single housing. FIG. 6D illustrates multiple regenerators 612, 614, 616 coupled to multiple air contactors 622, 624, 626. For example, one or more of regenerators 612, 614, 616 have discrete housings, and one or more of air contactors 622, 624, 626 have discrete housings. In addition, any combination of stages may be included in a single housing, for example, two stages of a regenerator or air contactor may share a housing while a third stage may have a separate housing. Thus, embodiments described herein may include a single staged regenerator, a single staged air contactor, multiple regenerators, multiple air contactors, and any combination thereof. While each of the above examples shows regenerator stages/regenerators coupled with an equal number of air contactor stages/air contactors, systems described herein may have unequal numbers of regenerator stages/devices and air contactor stages/devices. The sizes of each stage, or device, likewise are not required to be identical to each other.

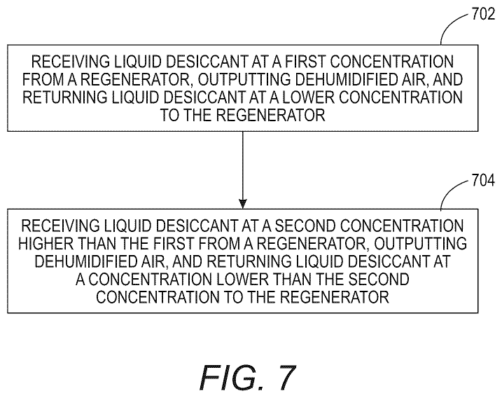

While embodiments described herein can involve a variety of configurations, staged liquid desiccant regeneration and dehumidification involves utilizing at least two concentrated liquid desiccant streams having different salt concentrations to dehumidify air using at least one salt concentration that is lower than a concentration required for an otherwise identical non-staged dehumidification system using a single salt concentration as set forth in FIG. 7. In certain embodiments liquid desiccant at a first concentration is received from a regenerator by an air contactor. The air contactor outputs air having a water content by percent mass that is lower than that of an incoming air stream to the air contactor and outputs a diluted liquid desiccant stream having a concentration lower than the input stream to the regenerator 702. This may be performed by a first stage of the air contactor. Liquid desiccant at a second concentration, higher than the first concentration is also received by the air contactor. The air contactor outputs air having a water content by percent mass that is lower than that of an incoming air stream to the air contactor and outputs a diluted liquid desiccant stream having a concentration lower than the second concentration to the regenerator 704. This may be performed by a second stage of the air contactor. For example, the air output from the second stage has a water content lower than water content of the air output from the first stage of the air contactor. In certain embodiments, the regenerator is a staged electrochemical liquid desiccant regenerator.

The systems described herein with respect to various embodiments involve a liquid desiccant regeneration system having staged outputs of at least two different desiccant concentrations in combination with a staged air contactor. These systems reduce energy consumption, particularly in electrochemically regenerated dehumidification and air conditioning systems, reduce system costs, increase the options for system operating ranges, and can reduce or eliminate the loss of desiccant materials in the system. They provide increased efficiency and environmentally responsible options for meeting the expected, increased need for dehumidification and air conditioning systems.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range. Also, all uses of “%” with respect to concentrations in the application refer to weight percent (wt. %) unless otherwise indicated.

The foregoing description has been presented for the purposes of illustration and description. It is not intended to be exhaustive or to limit the embodiments to the precise form disclosed. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

1.-22. (canceled)

23. A system, comprising:
a liquid desiccant regeneration system including:
a first liquid desiccant stage that outputs a first stream of liquid desiccant at a first concentration; and
a second liquid desiccant stage that outputs a second stream of liquid desiccant at a second concentration different from the first concentration;
an air contactor system including:
a first air contactor stage configured to dispose a first input air stream having a first water content by percent mass in contact with the first stream of liquid desiccant to form (1) a first output air stream having a second water content by percent mass that is lower than the first water content, and (2) a first diluted liquid desiccant stream, the first diluted liquid desiccant stream being circulated back into the liquid desiccant regeneration system; and
a second air contactor stage configured to dispose a second input air stream having a third water content by percent mass in contact with the second stream of liquid desiccant to form (1) a second output air stream having a fourth water content by percent mass that is lower than the third water content, and (2) a second diluted liquid desiccant stream, the second diluted liquid desiccant stream being circulated back into the liquid desiccant regeneration system;
a supply airflow path configured to flow the first input air stream to the air contactor system; and
a heat exchanger thermally coupled to the supply airflow path and configured to remove heat from the first input air stream upstream of the air contactor system.

24. The system of claim 23, wherein the second input air stream is the first output air stream, and the third water content is equal to the second water content.

25. The system of claim 23, wherein the first output air stream is combined with the second output air stream to produce a combined conditioned output air stream.

26. The system of claim 23, wherein the heat is sensible heat such that the heat exchanger provides sensible cooling, the heat exchanger being further configured to remove moisture from the first input air stream upstream of the air contactor system to provide latent cooling.

27. The system of claim 23, wherein the heat exchanger is further configured exchange heat between the first input air stream and water.

28. The system of claim 23, wherein the heat exchanger comprises an evaporator coil of a vapor compression system disposed within the supply airflow path and configured to remove heat from the first input air stream.

29. The system of claim 28, wherein a portion of the heat removed from the first input air stream is added to a regeneration airflow.

30. The system of claim 23, wherein liquid desiccant comprises at least one of LiCl, NaCl, LiBr, or CaCl₂.

31. The system of claim 23, wherein the liquid desiccant regeneration system is an electrochemical regeneration system driven by an electric potential.

32. The system of claim 23, wherein the liquid desiccant regeneration system is an electrochemical regeneration system driven by an electric potential that engenders faradaic reactions happening at two different electrodes, and material undergoing the faradaic reactions is circulated between the two different electrodes.

33. The system of claim 23, wherein the liquid desiccant regeneration system is driven by reverse osmosis.

34. The system of claim 23, wherein the liquid desiccant regeneration system is a thermal regeneration system.

35. The system of claim 34, wherein heat for thermal regeneration is provided by a heat exchanger thermally coupled to a regeneration airflow path and configured to add the heat to a regeneration airflow upstream of the liquid desiccant regeneration system.

36. The system of claim 35, wherein the heat exchanger is further configured to exchange heat between the regeneration airflow and water.

37. The system of claim 35, wherein the heat exchanger is further configured to exchange heat between the regeneration airflow and a condenser of a vapor compression system.

38. The system of claim 37, wherein the condenser is part of a vapor compression system, the heat exchanger further including an evaporator coil of the vapor compression system within the supply airflow path, the evaporator coil being configured to remove heat from the supply airflow.

39. The system of claim 23, wherein the third water content by percent mass is different from the first water content by percent mass.

40. The system of claim 23, wherein the first air contactor stage and the second air contactor stage are separate air contactors.

41. The system of claim 23, wherein the first air contactor stage and the second air contactor stage are stages of a same air contactor.

42. The system of claim 23, further comprising a heat removal system coupled to at least two streams of a group of streams, the group of streams comprising the first input air stream, the second input air stream, the first concentrated liquid desiccant stream, and the second concentrated liquid desiccant stream.

43. The system of claim 42, wherein the heat removal system comprises a first stage coupled to the first stream of liquid desiccant and a second stage coupled to the second stream of liquid desiccant.

44. The system of claim 42, wherein the heat removal system comprises vapor compression.

45. A method of conditioning an airflow comprising:
concentrating a first stream of liquid desiccant to a first concentration;
concentrating a second stream of liquid desiccant to a second concentration different from the first concentration;
circulating the first stream of liquid desiccant through a first air contactor stage of an air contactor system;
circulating the second stream of liquid desiccant through a second air contactor stage of the air contactor system;
disposing a first input air stream having a first water content by percent mass in contact with the first stream of liquid desiccant in the first air contactor stage to form (1) a first output air stream having a second water content by percent mass that is lower than the first water content, and (2) a first diluted liquid desiccant stream;
disposing a second input air stream having a third water content by percent mass in contact with the second stream of liquid desiccant in the second air contactor stage to form (1) a second output air stream having a fourth water content by percent mass that is lower than the third water content, and (2) a second diluted liquid desiccant stream, the first input air stream and the second input air stream being formed from a supply airstream; and
removing, with a heat exchanger, heat from the supply air upstream the first and second air contactor stages.

46. The method of claim 45, wherein the heat is sensible heat such that the removing the heat from the supply air provides sensible cooling, the method further comprising removing moisture from the supply airflow upstream of the first and second air contactor stages to provide latent cooling.

47. The method of claim 45, wherein the heat exchanger is configured to exchange heat between the supply airflow and water.

48. The method of claim 45, wherein the heat exchanger exchanges heat between an evaporator coil of a vapor compression system and the supply airflow.

49. The method of claim 45, wherein the second input air stream is the first output air stream, and the third water content is equal to the second water content.

50. The method of claim 45, further comprising combining the first output air stream with the second output air stream to produce a combined conditioned output air stream.

51. The method of claim 45, wherein the first air contactor stage and the second air contactor stage are separate air contactors.

52. The method of claim 45, wherein the first air contactor stage and the second air contactor stage are stages of a same air contactor.

53. The method of claim 45, wherein the second concentration is greater than the first concentration, and the first water content of the first input air stream is higher than the third water content of the second input air stream.

54. The method of claim 45, further comprising combining a portion of the first stream of liquid desiccant after the concentrating the first stream to the first concentration with the second stream of liquid desiccant before concentrating the second stream to the second concentration such that the concentrating the second stream includes concentrating the portion of the first stream.
